(19) United States
(12) Patent Application Publication
(10) Pub. No.: US 2009/0293567 A1
(43) Pub. Date: Dec. 3, 2009

(54) Door lock recording device

(76) Inventors: Ki Sheung Yuen, Brampton (CA); Ying Wai Chik, Mississauga (CA); Yiu Kong Wong, Richmond Hill (CA)

Correspondence Address: DENNISON ASSOCIATES, 133 RICHMOND STREET WEST, SUITE 301, TORONTO, ON, M5H 2L7, CA

(21) Appl. No.: 12/453,900

(22) Filed: May 27, 2009

Related U.S. Application Data
(60) Provisional application No. 61/130,146, filed on May 29, 2008.

(51) Int. Cl. E05B 19/22; E05B 19/00; G01P 15/00

(52) U.S. Cl. 70/391; 70/432; 70/436; 70/431; 73/488

(57) ABSTRACT

A device electronically tracks the use of a key to open or close a lockset and retain information of the key to allow a user to query the device and receive information with respect to the last recorded status. The device includes an actuating arrangement to allow tracking of the acceleration of the key during a locking or unlocking motion. These tracked signals are evaluated relative to at least two known signals indicative of a locking movement or an unlocking movement. The user is able to query the device at a later point in time and receive timing information of the present status and timing information between changes in status.

This application claims priority from U.S. Provisional Application 61/130,146 filed May 29, 2008.

### FIELD OF THE INVENTION

The present invention relates to an arrangement for tracking the use of a key during the opening and closing of a lockset. In addition, the invention is directed to a method of tracking the use of a key and providing an indication whether the key was recently used to lock or unlock a lockset.

### BACKGROUND OF THE INVENTION

There are occasions when a person cannot accurately recall whether a door lock was recently locked by the user. Typically the user questions the status of the lockset when it is no longer convenient to physically return and determine the status thereof. With mechanical locksets it is not possible to track this condition and it is certainly not possible to track this condition in association with the mechanical key used to operate the lockset. The present invention provides a device which can be built into a key of a mechanical lockset, or as an add-on device adapted for securement to a mechanical key for tracking the status of the lockset based on use of the key.

### SUMMARY OF THE INVENTION

The device according to the present invention tracks the use of a key in association with the opening or closing of a lockset. The device comprises a switch arrangement activated during the opening or closing of a lockset, an accelerometer associated with the key for detecting movement of the key during the opening and closing of the lockset, a processing arrangement for analyzing the detected movement of the key and determining whether the lockset has been opened or closed, and a processing arrangement for maintaining the status of the lockset based on the movement of the key. The device also includes a display for providing a visual indication of the status of the lockset as maintained by the processing arrangement. With this arrangement, the opening or closing of a lockset by use of a key is tracked and the device can provide the status of the lockset to the user upon demand.

In a preferred aspect of the invention, the switch arrangement is at one end of the device positioned to engage and be activated by the key when the key is inserted into a lockset.

In yet a further aspect of the invention, the device is adapted to receive and secure a portion of a key and maintain a fixed orientation therewith.

In yet a further aspect of the invention, a series of casings are provided with the device, and each casing is adapted to engage a key of a different thickness.

In a variation of the invention, the device for tracking the status of a key is determined by the use of the key to open or close a lockset. The device comprises a sensing arrangement for sensing rotation of a key in a lockset, a processing arrangement for evaluating the sensed signal and determining a locked status of the key or an unlocked status of the key by evaluating the sensed signal and determining a lock status if the sensed signal corresponds to a predetermined reference signal indicative of a signal produced during rotation of the key to lock a lockset and determining an unlocked status if the sensed signal corresponds to a predetermined reference signal indicative of a signal produced during rotation of the key to unlock a lockset.

The device also includes a display arrangement on the device for displaying the most recent status of the key.

In a preferred aspect of the invention, the device includes an accelerometer used to detect rotation of the key during opening and closing of the lockset.

In yet a further aspect of the invention, a switch arrangement is provided with the switch arrangement being used to activate the device upon insertion of the key into a lockset.

The present invention is also directed to a method of tracking use of a key to lock or unlock a lockset and comprises the steps of sensing rotation of a key in a lockset, determining a locked status of the key if the sensed rotation corresponds to a predetermined signal indicative of key rotation to lock a lockset, or determining an unlocked status of the key if the sensed signal is indicative of a predetermined signal corresponding to rotation of the key to unlock a lockset. The method further includes selectively displaying the determined status of the lockset operated by the key.

In a preferred embodiment, a switch arrangement is provided for selectively displaying the determined status of the key when the switch is activated.

In an aspect of the invention, the method includes an initial step of turning on an electronic circuit when the key is inserted in the lockset, and using the electronic circuit to complete the steps of sensing the rotation of the key, determining the status of the key, and selectively displaying the determined status of the key.

In a preferred aspect of the invention, the method includes maintaining time information from the last change in status of the key and displaying the time information upon a user exercised request for such information.

In a preferred embodiment of the invention, the user exercise request is inputted by activating a switch.

In yet a further aspect of the invention, the method includes using an electronic accelerometer to sense rotation of the key.

### BRIEF DESCRIPTION OF THE DRAWINGS

Preferred embodiments of the invention are shown in the drawings, wherein:

FIG. 1 is a front view of the device secured to a key;

FIG. 2 is a rear view of the device secured to a key;

FIG. 3 is a schematic view of the electronic circuit used with the device;

FIG. 4 is a schematic view illustrating the principles of the accelerometer;

FIG. 5 is an illustration of the wave form of the unfiltered x-axis signal and filtered z-axis signal of the accelerometer;

FIG. 6 illustrates a typical wave form of the x-axis signal and the y-axis signal, both before the filtering process;

FIG. 7 illustrates the device with a cover removed to allow a key to be inserted therein;

FIG. 8 is a view of the device with the rear cover secured to fasten the key in the device;

FIG. 9 is a front view of the device and secured key; and

FIGS. 10 through 12 show the device with different thicknesses of covers for accommodating different key thicknesses.

### DETAILED DESCRIPTION OF THE PREFERRED EMBODIMENTS

The tracking device 1 is designed to receive the head portion of the key 2 such that the shaft 2a of the key has a fixed orientation with the device 1. A series of LEDs 11a, 11b and 11c are provided on a face of the device 1 and these LEDs can provide information with respect to the locked status or unlocked status of the tracking device 1 and can additionally communicate timing information relative to the last occurrence of a change in status of the tracking device.

As shown in the rear view of FIG. 2, the removable cover 15 is secured to the device by a series of screws 16 and the head portion of the key 2 is received within the device 1. The tracking device 1 includes a user activated switch 10 to allow a user to request the status of the tracking device. This switch 10 is actuated when a person wishes to recall the last time the tracking device was used in association with a locking or unlocking function of a lockset.

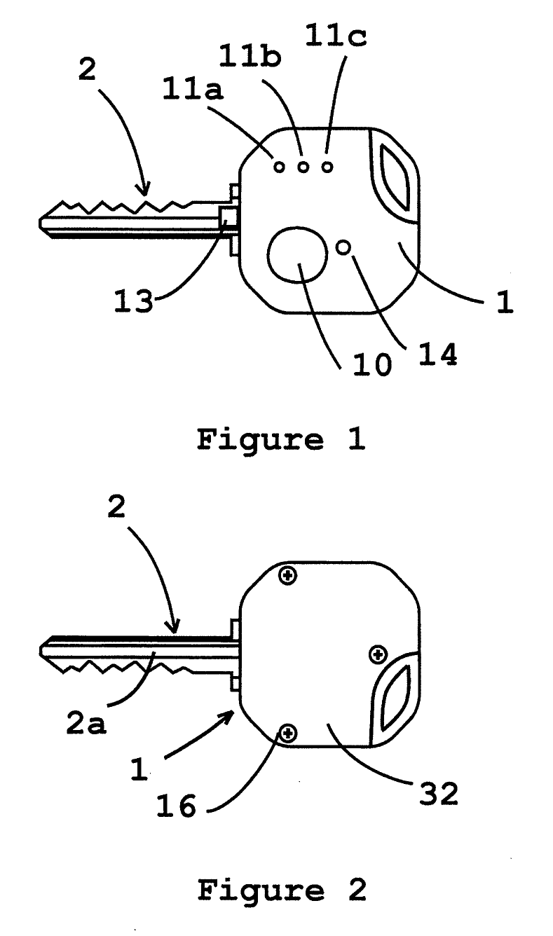

FIG. 1 also illustrates a mechanically actuated switch 13 which is activated when the key is inserted in a lockset. This switch turns on an electronic circuit of the tracking device and allows the device to determine whether a locking or an unlocking rotation of the key has occurred. Although a mechanical switch is shown, other arrangements for activating the circuit can be used and an activating arrangement is preferred to conserve power consumption. Some circuits can include a low power sleep mode that is activated when a sensed condition is determined.

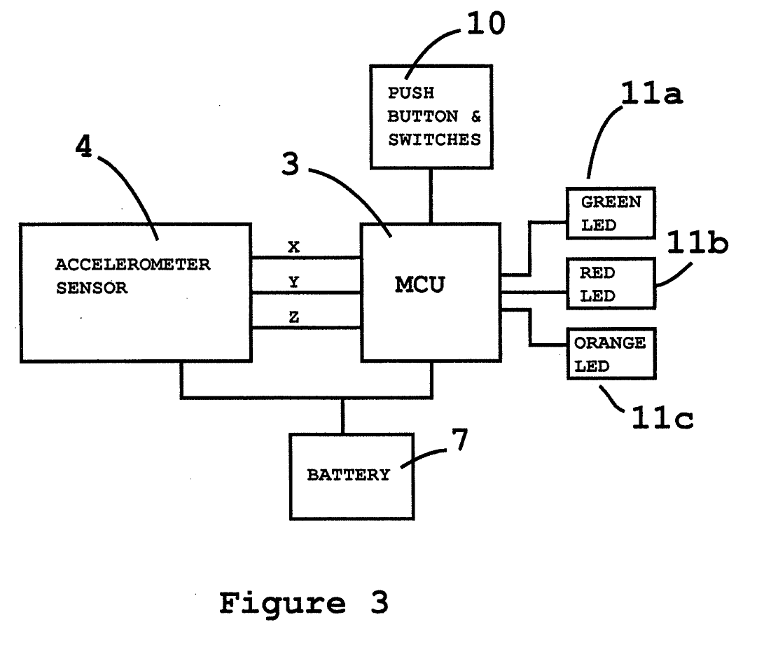

The tracking device 1 as shown in FIG. 3 includes an accelerometer sensor 4 used to sense rotation of the tracking device 1 (and thus rotation of the key) as the key is rotated. Basically, the tracking device is fixed to a head portion of the key, and the key is rotated by rotation of the tracking device.

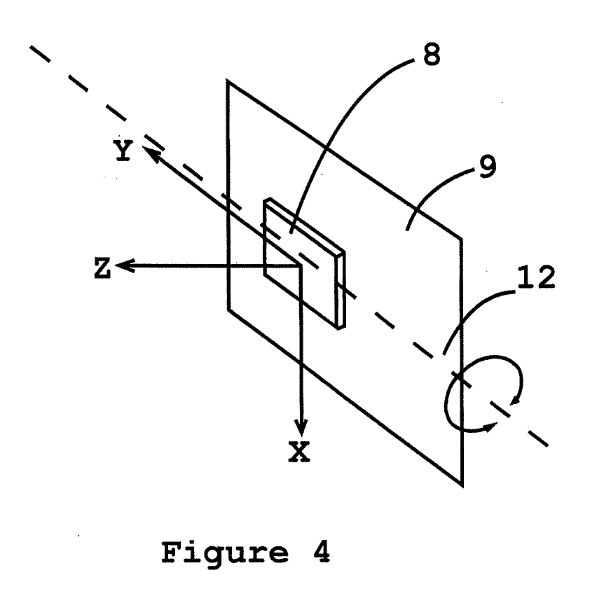

The accelerometer 4 as shown in FIG. 4 allows sensing of motion relative to the X, Y and Z axes. In the embodiment shown in FIG. 4, the sensor 8 is mounted on a circuit board 9 and the accelerometer has the Y-axis aligned with the elongate shank of the key. With this arrangement, acceleration along the Y-axis during locking or unlocking is essentially zero, and the change in the signal will be with respect to the X and Z axes.

The signal sensed by the accelerometer is processed by the processing arrangement 3 which is a micro-controller unit. This processing circuit is powered by the battery 7 and is turned on or off by the push actuator 5. The processing unit 3 also activates the appropriate LEDs 11a, 11b or 11c when a user activates the switch 10. These LEDs effectively communicate the status of the tracking device whereby a user can determine whether the lockset is locked or unlocked as last tracked by the device.

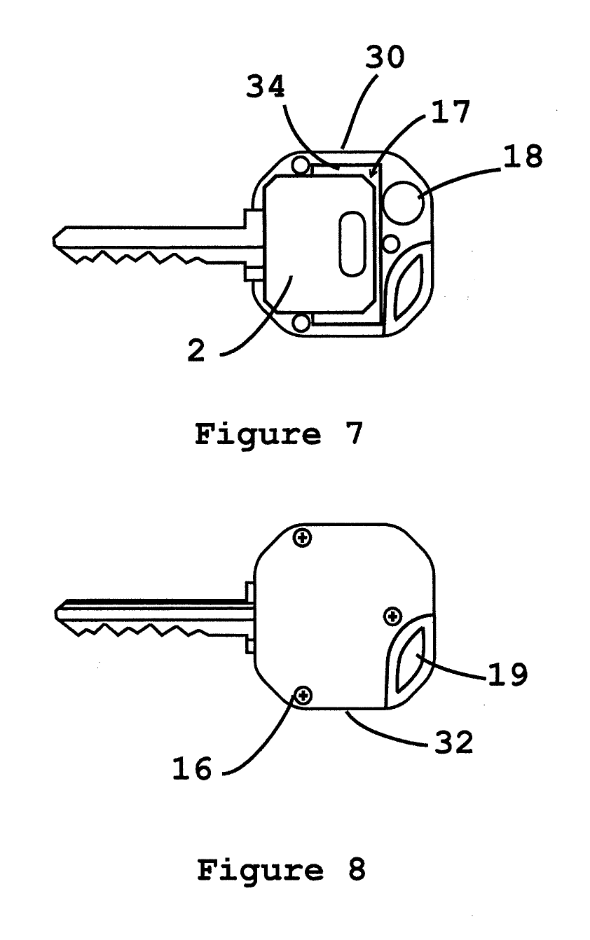

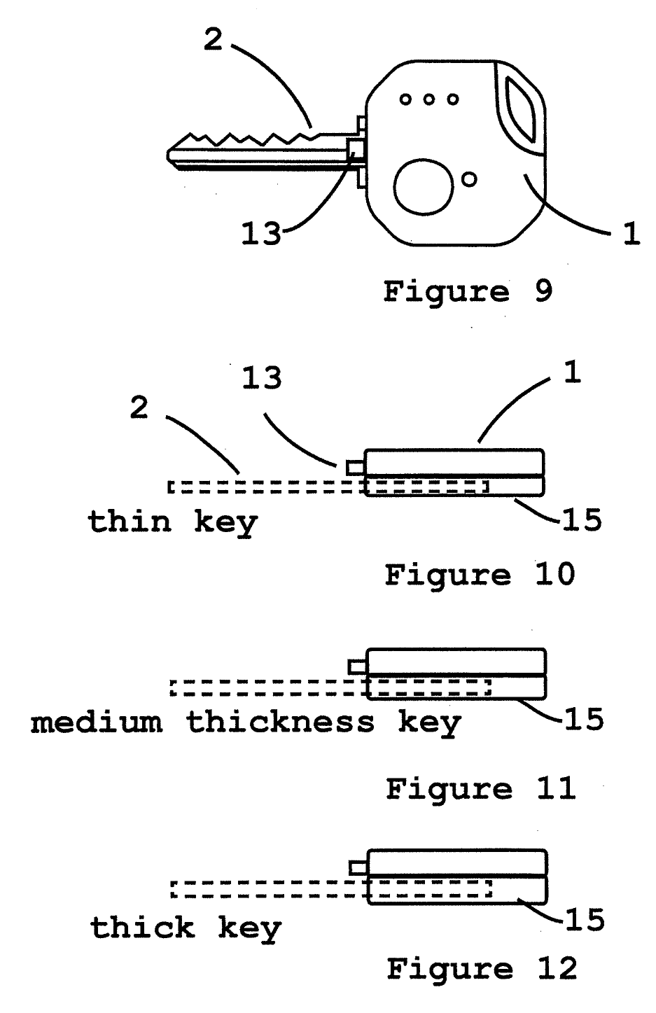

As shown in FIGS. 7 through 12, the device 1 includes a two part casing 30 and 32 having a central cavity 34 therebetween sized for receiving the head portion of the key 2. Once the key has been inserted and secured within the casing 30, the rear casing 32 can be mechanically secured to the first casing by means of the screws 16. The casing 30 also includes a port 19 for allowing the device to be secured to a key ring.

To use the tracking device 1, the user will have previously secured the key 2 in the device and positioned the key such that the switch 13 will be activated i.e. pushed in when the key is inserted in the lockset as the switch 13 abuts the face of the lockset. The activation of switch 13 turns on the processing arrangement 3 and causes the processing arrangement to track movement using the accelerometer 4. As can be appreciated, at this point the key has been inserted in the lockset and preferably the Y-axis of the accelerometer is aligned with the elongate shank 2a of the key 2.

The 3-axis accelerometer is preferred, however it can be appreciated that a 2-axis accelerometer could also function appropriately if it is orientated to provide the preferred orientation of the two axes.

As shown in FIG. 3, the accelerometer is an integrated circuit 8 and is mounted on the printed circuit board 9 with the X, Y and Z axes as shown. A key is inserted into the device and the device and key rotate during movement of the key to perform a locking or unlocking of the lockset. In the embodiment shown, the key rotational axis 12 is parallel to the Y axis of the accelerometer.

Once the device has been turned on, the signal from the accelerometer produces components on the X, Y and Z axis and the microcontroller includes filtering of these signals to produce a signal reflective of the turning motion of the key as well as changes in direction of movement associated with the rotation of the key in the lockset.

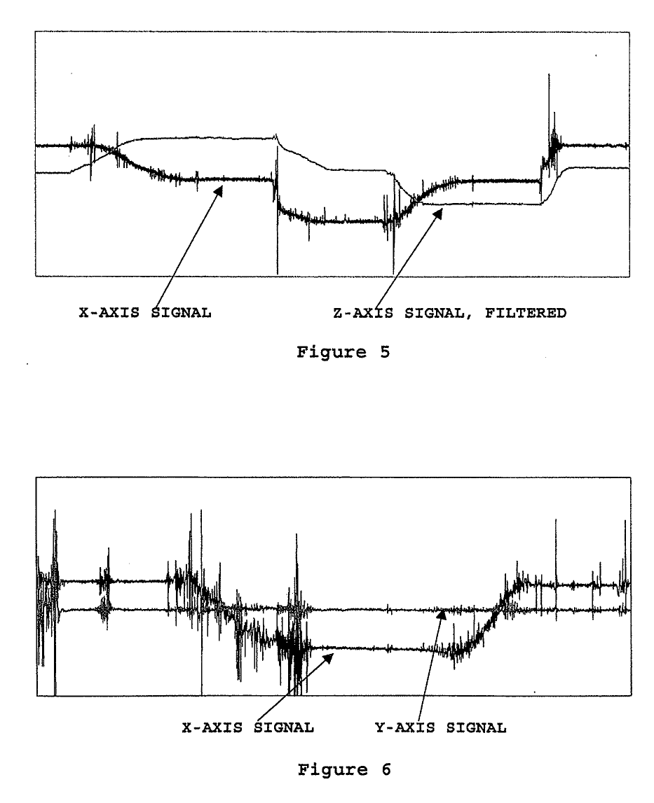

The signal shown in FIG. 5 provides traces of the X and Z signals. Rotation is in a counter-clockwise direction through a complete 360° rotation stopping briefly at 90°, 180° and 270°. The Z signal shown has been filtered.

FIG. 6 shows the capture of the X and Y signals and includes rotation in a clockwise direction through 180° followed by counter-clockwise rotation through 180°. The key rotation axis is parallel to the Y-axis, and the X and Z axes are on the plane of rotation.

The signal is analyzed to determine the rising or falling of the X and Z signals, and this allows determination of a clockwise or counter-clockwise turning of the key as shown in the table below. The initial orientation is the key insertion orientation.

| | | | | |
|---|---|---|---|---|
| initial | 0-90 | 90-180 | 180-270 | 270-360 |
| position | degrees | degrees | degrees | degrees |

Turn key counter clockwise

| | | | | | |
|---|---|---|---|---|---|
| X axis | maximum | falling | falling | rising | rising |
| Z axis | mid value | rising | falling | falling | rising |

Turn key clockwise

| | | | | | |
|---|---|---|---|---|---|
| X axis | maximum | falling | falling | rising | rising |
| Z axis | mid value | falling | rising | rising | falling |

From the above, it can be appreciated that when a key is inserted in a lockset the device is effectively turned on, and the accelerometer is used to track the rotation of the key. These sensed signals are compared to a series of reference signals indicative of the motion of the key to produce a locked status of the lockset, and the motion of the key to effectively unlock the lockset. Preferably, the device allows for an initial learn function where the user activates the device and rotates the key to unlock the device. Typically, the locking rotation and the unlocking rotation are the reverse of each other. Therefore, tracking of the rotation of the key to perform one of these functions allows the device to store a signal representing a locking of the lockset and a signal reflective of the unlocking of the lockset. If the user incorrectly enters the initial signals, recessed switch 14 can reverse the signals. For example, if the device when used to lock the lockset indicates the lockset is unlocked, the initial signals were reversed. Activating switch 14 reverses the predetermined signals and the device correctly tracks the status.

In any event, the microcontroller has information to determine whether a sensed signal produced by the device is indicative of a locking of a lockset or unlocking of a lockset. It also allows the device to only recognize these motions as locking or unlocking motions. With this arrangement, the use of the tracking device allows a user to maintain information regarding the use of the key.

The device is preferably automatically activated when the key is inserted in a lockset, and the motion of the key is evaluated relative to a known reference signal to determine whether a lockset has been locked or unlocked. Thus, the device is able to determine whether a change in the status of the tracking device has occurred indicative of a locking or unlocking of the lockset.

At a later point in time, if a user requires confirmation of the status of the key, he can merely press switch button 10 and one of the LEDs 11a, 11b or 11c will be illuminated. Preferably, 11a is a green LED indicative of the lockset being locked, and 11b is a red LED indicative of the lockset being open. An orange LED 11c can be used to provide timing information relative to the last change in the status of the tracking device. The orange LED can be used to show whether the last change in status occurred within a relatively short time, for example, the last 15 minutes, or a long time, for example, 6 hours ago. In the last 15 minutes the LED can be pulsed, for example, and after six hours the LED can be merely on. In another embodiment, the orange LED does not turn on if the change in status occurred within a relatively short time, for example, 15 minutes, and flashes if the event occurred in a time period greater than 15 minutes and less than 6 hours. If the event occurred in a time period six hours or greater, the LED would merely stay on. In this way, timing information can be communicated to the user. Other arrangements are possible for communicating this information.

The embodiments shown in FIGS. 7 through 12 illustrate that the device can be used with a number of different types and sizes of keys. The rear casing 15 is a molded plastic casing, and preferably the device is sold with three different sizes of casings allowing it to be customized for particular keys. The key 2 is preferably adhesively secured within the cavity 17 of the device to maintain the fixed orientation.

The accelerometer used in the present device is part of an IC chip (integrated circuit) that is available from a number of different manufacturers. For example, Freescale Semiconductor (MMA 7260QT) produces a suitable accelerometer as does STMicroelectronics (LIS344AL).

The sensing cell is a mechanical structure formed from semiconductor materials (polysilicon) using semiconductor processes. It can be described as a set of plates attached to a movable central mass that moves between fixed plates. The movable plates can be deflected from their rest position by subjecting the system to acceleration, such as the earth's gravity g.

As the plates attached to the central mass move, the distance from them to the fixed plate on one side will increase by the same amount that the distance to the fixed plate on the other side decreases. The change in distance is a measure of acceleration.

Accelerometers are typically constructed with 2 axes (X, Y) or 3 axes (X, Y, Z).

Although various preferred embodiments of the present invention have been described herein in detail, it will be appreciated by those skilled in the art, that variations may be made thereto without departing from the spirit of the invention or the scope of the appended claims.

The embodiments of the invention in which an exclusive property or privilege is claimed are defined as follows:

1. A status device for tracking the use of a key in association with the opening or closing of a lockset, said device comprising
a switch arrangement activated during the opening or closing of a lockset,
an accelerometer associated with said key for detecting movement of the key during the opening and closing of the lockset,
a processing arrangement for analyzing the detected movement of the key and determining whether the lockset has been opened or closed,
said processing arrangement maintaining a status of the lockset based on the movement of the key, and
a display for providing a visual indication of the status of the lockset as maintained by the processing arrangement.

2. A device as claimed in claim 1 wherein said switch arrangement is at one end of said device positioned to engage and be activated by the key being inserted in said lockset.

3. A device as claimed in claim 1 wherein said device is adapted to receive and secure a portion of a key and maintain a fixed orientation therewith.

4. A device as claimed in claim 3 including a series of casings adapted to snuggly receive keys of different thicknesses.

5. A device as claimed in claim 1 including on an exterior face thereof at least two light emitting diodes and a manual switch,
said manual switch when activated producing a signal to query the device as to the latest status of the lockset as tracked by the device and providing an output signal indicative of the latest status.

6. A device as claimed in claim 5 including a pulsing function used to pulse one of said light emitting diodes and provide timing information as to the occurrence of the last detected changed in status.

7. A device as claimed in claim 3 wherein said accelerometer is a 3 axis accelerometer.

8. A device as claimed in claim 7 wherein one of said axis of said accelerometer is aligned with an elongate shank of said key when said key is received in said device.

9. A device as claimed in claim 8 wherein said device detects and measures during both said opening and closing of the lockset both a rotation and a counter rotation to determine a change in status of said lockset.

10. A device as claimed in claim 9 wherein said device is built into a key.

11. A device as claimed in claim 1 having a casing adapted to engage different sizes and configurations of keys.

12. A device for tracking the status of a key determined by the use of the key to open or close a lockset, said device comprising
a sensing arrangement for sensing rotation of a key in a lockset;
a processing arrangement for evaluating the sensed signal and determining a locked status of said key or an unlocked status of said key by evaluating the sensed signal and determining a locked status if the sensed signal corresponds to a predetermined reference signal indicative of a signal produced during rotation of the key to lock a lockset and determining an unlocked status if the sensed signal corresponds to a predetermined reference signal indicative of a signal produced during rotation of the key to unlock a lockset;
a display arrangement on said device for selectively displaying the most recent status of said key.

13. A device as claimed in claim 12 wherein said device includes an accelerometer used to detect rotation of the key during the opening and closing of the lockset.

14. A device as claimed in claim 13 including a switch arrangement used to activate said device upon insertion of said key in a lockset.

15. A device as claimed in claim 14 wherein said display arrangement includes a visual indication of the status of the lockset as maintained by the processing arrangement.

16. A method of tracking use of a key to lock or unlock a lockset comprising the steps of
sensing rotation of a key in a lockset;
determining a locked status of said key if the sensed rotation corresponds to a predetermined signal indicative of key rotation to lock a lockset or determining a unlocked status of said key if said sensed signal is indicative of a predetermined signal corresponding to rotation of said key to unlock a lockset; and
selectively displaying the determined status of said key.

17. A method as claimed in claim 16 including an initial step of turning on an electronic circuit when the key is inserted in the lockset and using said electronic circuit to complete the steps of sensing rotation of the key, determining the status of the key and selectively displaying the determined status of the key.

18. A method as claimed in claim 17 including maintaining time information from the last change in status of the key and displaying the time information upon a user exercised request for such information.

19. A method as claimed in claim 18 including using an electronic accelerometer to sense rotation of said key.

20. A method as claimed in claim 18 wherein said method is included in a device adapted to receive a portion of a key and maintain a fixed orientation with said key.
